(19) United States
(12) Patent Application Publication
(10) Pub. No.: US 2010/0285351 A1
(43) Pub. Date: Nov. 11, 2010

(54) Li-ION BATTERY WITH ANODE EXPANSION AREA

(75) Inventors: Boris Kozinsky, Newton, MA (US); John F. Christensen, Mountain View, CA (US); Nalin Chaturvedi, Sunnyvale, CA (US); Jasim Ahmed, Mountain View, CA (US)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: ROBERT BOSCH GMBH, Stuttgart (DE)

(21) Appl. No.: 12/437,791

(22) Filed: May 8, 2009

(51) Int. Cl. H01M 2/02; H01M 4/58

(52) U.S. Cl. 429/163; 429/218.1; 977/762

(57) ABSTRACT

An electrochemical cell in one embodiment includes a first electrode including a form of sulfur as an active material, a second electrode spaced apart from the first electrode, the second electrode including a plurality of nanowires, and a transfer member operably contacting the first electrode and the second electrode to transfer one or more of pressure and volume between the first electrode and the second electrode.

Cross-reference is made to U.S. Utility patent application Ser. No. 12/437,576 entitled “Li-ion Battery with Selective Moderating Material” by John F. Christensen et al., which was filed on May 8, 2009; U.S. Utility patent application Ser. No. 12/437,592 entitled “Li-ion Battery with Blended Electrode” by John F. Christensen et al., which was filed on May 8, 2009; U.S. Utility patent application Ser. No. 12/437,606 entitled “Li-ion Battery with Variable Volume Reservoir” by John F. Christensen et al., which was filed on May 8, 2009; U.S. Utility patent application Ser. No. 12/437,622 entitled “Li-ion Battery with Over-charge/Over-discharge Failsafe” by John F. Christensen et al., which was filed on May 8, 2009; U.S. Utility patent application Ser. No. 12/437,643 entitled “System and Method for Pressure Determination in a Li-ion Battery” by John F. Christensen et al., which was filed on May 8, 2009; U.S. Utility patent application Ser. No. 12/437,745 entitled “Li-ion Battery with Load Leveler” by John F. Christensen et al., which was filed on May 8, 2009; U.S. Utility patent application Ser. No. 12/437,774 entitled “Li-ion Battery with Anode Coating” by Boris Kozinsky et al., which was filed on May 8, 2009; U.S. Utility Patent Application Serial No. [Attorney Docket No. 1576-0305] entitled “Li-ion Battery with Porous Silicon Anode” by Boris Kozinsky et al., which was filed on May 8, 2009; U.S. Utility Patent Application Serial No. [Attorney Docket No. 1576-0306] entitled “Li-ion Battery with Rigid Anode Framework” by Boris Kozinsky et al., which was filed on May 8, 2009; U.S. Utility Patent Application Serial No. [Attorney Docket No. 1576-0308] entitled “System and Method for Charging and Discharging a Li-ion Battery” by Nalin Chaturvedi et al., which was filed on May 8, 2009; and U.S. Utility Patent Application Serial No. [Attorney Docket No. 1576-0310] entitled “System and Method for Charging and Discharging a Li-ion Battery Pack” by Nalin Chaturvedi et al., which was filed on May 8, 2009, the entirety of each of which is incorporated herein by reference. The principles of the present invention may be combined with features disclosed in those patent applications.

### FIELD OF THE INVENTION

This invention relates to batteries and more particularly to lithium-ion batteries.

### BACKGROUND

Batteries are a useful source of stored energy that can be incorporated into a number of systems. Rechargeable lithium-ion batteries are attractive energy storage systems for portable electronics and electric and hybrid-electric vehicles because of their high specific energy compared to other electrochemical energy storage devices. In particular, batteries with a form of lithium metal incorporated into the negative electrode afford exceptionally high specific energy (in Wh/kg) and energy density (in Wh/L) compared to batteries with conventional carbonaceous negative electrodes.

When high-specific-capacity negative electrodes such as lithium are used in a battery, the maximum benefit of the capacity increase over conventional systems is realized when a high-capacity positive electrode active material is also used. Conventional lithium-intercalating oxides (e.g., LiCoO₂, LiNi_{0.8}Co_{0.15}A_{0.05}O₂, Li_{1.1}Ni_{0.3}Co_{0.3}Mn_{0.3}O₂) are typically limited to a theoretical capacity of ˜280 mAh/g (based on the mass of the lithiated oxide) and a practical capacity of 180 to 250 mAh/g. In comparison, the specific capacity of lithium metal is about 3863 mAh/g. The highest theoretical capacity achievable for a lithium-ion positive electrode is 1168 mAh/g (based on the mass of the lithiated material), which is shared by Li₂S and Li₂O₂. Other high-capacity materials including BiF₃ (303 mAh/g, lithiated) and FeF₃ (712 mAh/g, lithiated) are identified in Amatucci, G. G. and N. Pereira, Fluoride based electrode materials for advanced energy storage devices. Journal of Fluorine Chemistry, 2007. 128(4): p. 243-262. All of the foregoing materials, however, react with lithium at a lower voltage compared to conventional oxide positive electrodes, hence limiting the theoretical specific energy. The theoretical specific energies of the foregoing materials, however, are very high (>800 Wh/kg, compared to a maximum of ˜500 Wh/kg for a cell with lithium negative and conventional oxide positive electrodes).

Lithium/sulfur (Li/S) batteries are particularly attractive because of the balance between high specific energy (i.e., >350 Wh/kg has been demonstrated), rate capability, and cycle life (>50 cycles). Only lithium/air batteries have a higher theoretical specific energy. Lithium/air batteries, however, have very limited rechargeability and are still considered primary batteries.

Li/S batteries also have limitations. By way of example, the United States Advanced Battery Consortium has established a goal of >1000 cycles for batteries used in powering an electric vehicle. Li/S batteries, however, exhibit relatively high capacity fade, thereby limiting the useful lifespan of Li/S batteries.

One mechanism which may contribute to capacity fade of Li/S batteries is the manner in which the sulfur reacts with lithium. In general, sulfur reacts with lithium ions during battery discharge to form polysulfides (LiₓS), which may be soluble in the electrolyte. These polysulfides react further with lithium (i.e., the value of x increases from ¼ to ⅓ to ½ to 1) until Li₂S₂ is formed, which reacts rapidly to form Li₂S. In Li/S batteries described in the literature, both Li₂S₂ and Li₂S are generally insoluble in the electrolyte. Hence, in a system in which intermediate polysulfides are soluble, each complete cycle consists of soluble-solid phase changes, which may impact the integrity of the composite electrode structure.

Specifically, Li₂S may deposit preferentially near the separator when the current through the depth of the positive electrode is non-uniform. Non-uniformity is particularly problematic at high discharge rates. Any such preferential deposition can block pores of the electrode, putting stress on the electronically conducting matrix and/or isolating an area from the composite electrode. All of these processes may lead to capacity fade or impedance rise in the battery.

Moreover, soluble polysulfides are mobile in the electrolyte and, depending on the type of separator that is used, may diffuse to the negative electrode where the soluble polysulfides may becoming more lithiated through reactions with the lithium electrode. The lithiated polysulfide may then diffuse back through the separator to the positive electrode where some of the lithium is passed to less lithiated polysulfides. This overall shuttle process of lithium from the negative electrode to the positive electrode by polysulfides is a mechanism of self discharge which reduces the cycling efficiency of the battery and which may lead to permanent capacity loss.

Some attempts to mitigate capacity fade of Li/S batteries rely upon immobilization of the sulfur in the positive electrode via a polymer encapsulation or the use of a high-molecular weight solvent system in which polysulfides do not dissolve. In these batteries, the phase change and self-discharge characteristics inherent in the above-described Li/S system are eliminated. These systems have a higher demonstrated cycle life at the expense of high rate capability and capacity utilization.

In the case of a Li/S battery, however, the sulfur active material increases in volume by 80% as it becomes lithiated during battery discharge. Thus, an all solid-state cathode, composed of sulfur (or lithiated sulfur) and a mixed conducting material, particularly if the latter is a ceramic, is susceptible to fracture due to the volume change upon battery cycling. Fracture of the cathode can result in capacity fade and is a potential safety hazard due to venting of the cell. Other materials which exhibit desired capabilities when incorporated into a battery also exhibit significant increases in volume. By way of example, LiSi, typically used as an anode material, exhibits a large increase in volume during operation.

What is needed therefore is a battery that provides the benefits of materials that exhibit large volume changes during operation of the cell while reducing the likelihood of cell venting or fracture of material within the cell.

### SUMMARY

In accordance with one embodiment, an electrochemical cell includes a first electrode including a form of sulfur as an active material, a second electrode spaced apart from the first electrode, the second electrode including a plurality of nanowires, and a transfer member operably contacting the first electrode and the second electrode to transfer one or more of pressure and volume between the first electrode and the second electrode.

### BRIEF DESCRIPTION OF THE DRAWINGS

FIG. 1 depicts a schematic of a battery system including an electrochemical cell with a cathode including a material that exhibits significant volume changes as the electrochemical cell cycles and an anode including a plurality of nanowires, the anode configured as an pressure buffer to reduce peek pressure within the cell resulting from the cathodic volume increase; and

FIG. 2 depicts a schematic of the battery system of FIG. 1 after a significant increase in the volume of the cathode active material.

### DESCRIPTION

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

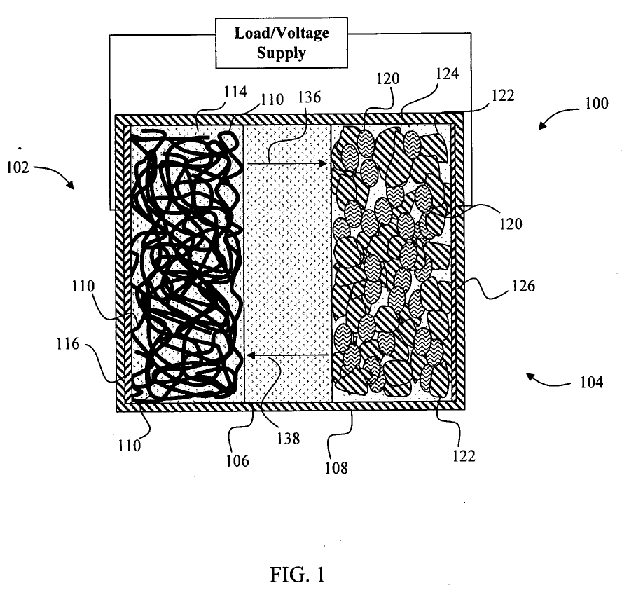

FIG. 1 depicts a lithium-ion cell 100, which includes a negative electrode 102, a positive electrode 104, and a separator region 106 between the negative electrode 102 and the positive electrode 104. The negative electrode 102, the positive electrode 104, and the separator region 106 are located within a pouch 108. The negative electrode 102 includes nanotubes or nanowires 110 which in this embodiment are an amorphous mixture of inert materials, and active materials into which lithium can be inserted and inert materials. The inert materials may include silicon. Alternatively, the inert material may include any other element that alloys with Li, such as Sn, Al, Mg, etc.

The separator region 106 is configured to be more flexible than the pouch 108. Flexibility may be achieved by selection of materials, by manner of fabrication, or some combination of materials and fabrication processes. The separator 106 in one embodiment includes an electrolyte with a lithium cation and serves as a physical and electrical barrier between the negative electrode 102 and the positive electrode 104 so that the electrodes are not electronically connected within the cell 100 while allowing transfer of lithium ions between the negative electrode 102 and the positive electrode 104.

The positive electrode 104 includes active material 120 into which lithium can be inserted, inert material 122, the electrolyte 114, and a current collector 126. The active material 120 includes a form of sulfur and may be entirely sulfur.

The lithium-ion cell 100 operates in a manner similar to the lithium-ion battery cell disclosed in U.S. patent application Ser. No. 11/477,404, filed on Jun. 28, 2006, the contents of which are herein incorporated in their entirety by reference. In general, electrons are generated at the negative electrode 102 during discharging and an equal amount of electrons are consumed at the positive electrode 104 as lithium and electrons move in the direction of the arrow 136 of FIG. 1.

In the ideal discharging of the cell 100, the electrons are generated at the negative electrode 102 because there is extraction via oxidation of lithium ions from the nanowires 110 of the negative electrode 102, and the electrons are consumed at the positive electrode 104 because there is insertion of lithium ions into the active material 120 of the positive electrode 104. During discharging, the reactions are reversed, with lithium and electrons moving in the direction of the arrow 138.

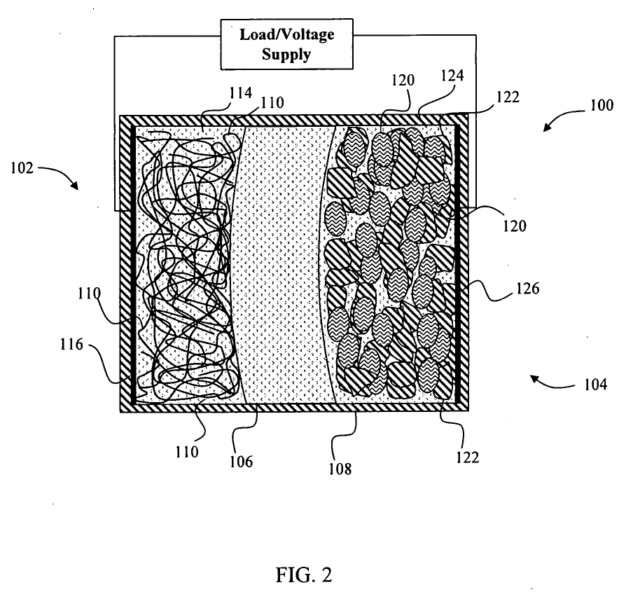

As lithium is reduced into the active material 120, the volume of the active material 120 increases. This is depicted in FIG. 2 by the increased size of the individual particles of active material 120 compared to the size of the individual particles of active material 120 in the FIG. 1. As the volume of the active material 120 increases, the pressure within the positive electrode 104 increases. As discussed above, the separator 106 is more flexible than the pouch 108. Accordingly, the increased pressure in the positive electrode 104, in one embodiment, causes the separator layer 106 to deform toward the negative electrode 102. Because the nanowires 110 do not fill the entire negative electrode 102, the separator layer 106 can displace the nanowires 110, reducing the volume of the negative electrode 102. While nanowires 110 are shown as providing porosity for the negative electrode 102, porosity of the negative electrode 102 may be provided in other ways. As the volume of the negative electrode 102 decreases, the pressure within the negative electrode 102 increases.

As lithium is inserted into the active material 120, however, lithium is removed from the nanowires 110. Accordingly, the volume occupied by the nanowires 110 reduces thereby mitigating pressure increase within the electrode 102. The change in volume in the negative electrode 102 due to the reduction in size of the nanowires 110 may not be, however, as large as the change in volume of the active material 120 in the positive electrode 104. Therefore, the overall pressure within the cell 100 may increase. The peak local pressure within the cell 100, however, is reduced because the pressure increase is not absorbed solely by the positive electrode 104. The negative electrode 102 thus serves as a pressure buffer to reduce the effects of the increasing volume in the positive electrode 104.

In the embodiment of FIG. 1, discussed above, the separator 106 acts as a “volumetric transfer member.” A “transfer member” is defined as a component through which pressure is transferred between electrodes or which allows the respective volumes of the electrodes to be modified in an inverse relationship. Thus, a “volumetric transfer member” “transfers” volume between electrodes while a “pressure transfer member” allows pressure to be transferred between electrodes.

Accordingly, a separator which does not allow fluid to pass from one electrode to the other electrode functions primarily as a volumetric transfer member. Thus, a separator in a solid state cell in which the separator is the electrolyte functions primarily as a volumetric transfer member, increasing the volume of the cathode as the sulfur active material expands. A separator that is as rigid as the cell pouch, but which allows fluid to move between electrodes, functions primarily as a pressure transfer member. A separator that is less rigid than the cell pouch, and which allows fluid to move between electrodes, functions as both a volumetric transfer member and a pressure transfer member. Such separators can be made of porous electronically insulating polymers (such as polypropylene) or ceramic materials (such as LIPON or LISICON) or a combination of these materials.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

1. An electrochemical cell, comprising:
a first electrode including a form of sulfur as an active material;
a second electrode spaced apart from the first electrode, the second electrode including a plurality of nanowires; and
a transfer member operably contacting the first electrode and the second electrode to transfer one or more of pressure and volume between the first electrode and the second electrode.

2. The electrochemical cell of claim 1, wherein the transfer member comprises a separator positioned between the first electrode and the second electrode.

3. The electrochemical cell of claim 2, further comprising:
a pouch having a first rigidity, the first electrode, the second electrode, and the transfer member located within the pouch, wherein the separator has a second rigidity, the second rigidity less than the first rigidity.

4. The electrochemical cell of claim 3, wherein the separator is configured to allow a fluid to pass from the first electrode to the second electrode.

5. The electrochemical cell of claim 1, wherein the separator is configured to allow a fluid to pass from the first electrode to the second electrode.

6. The electrochemical cell of claim 5, further comprising:
a pouch having a first rigidity, the first electrode, the second electrode, and the transfer member located within the pouch, wherein the separator has a second rigidity, the second rigidity less than the first rigidity.

7. The electrochemical cell of claim 5, further comprising:
a pouch having a first rigidity, the first electrode, the second electrode, and the transfer member located within the pouch, wherein the separator has a second rigidity and the second rigidity is not less than the first rigidity.

8. The electrochemical cell of claim 1, wherein the plurality of nanowires comprise a form of silicon.

9. The electrochemical cell of claim 8, wherein the transfer member comprises a separator positioned between the first electrode and the second electrode.

10. The electrochemical cell of claim 9, further comprising:
a pouch having a first rigidity, the first electrode, the second electrode, and the transfer member located within the pouch, wherein the separator has a second rigidity, the second rigidity less than the first rigidity.

11. The electrochemical cell of claim 10, wherein the separator is configured to allow a fluid to pass from the first electrode to the second electrode.

12. The electrochemical cell of claim 8, wherein the separator is configured to allow a fluid to pass from the first electrode to the second electrode.

13. The electrochemical cell of claim 12, further comprising:
a pouch having a first rigidity, the first electrode, the second electrode, and the transfer member located within the pouch, wherein the separator has a second rigidity, the second rigidity less than the first rigidity.

14. The electrochemical cell of claim 12, further comprising:
a pouch having a first rigidity, the first electrode, the second electrode, and the transfer member located within the pouch, wherein the separator has a second rigidity and the second rigidity is not less than the first rigidity.
